(19) United States
(12) Patent Application Publication
(10) Pub. No.: US 2022/0219310 A1
(43) Pub. Date: Jul. 14, 2022

(54) VEHICLE CREEPER

(71) Applicant: Craig Christopher Poitras, St. Paul (CA)

(72) Inventor: Craig Christopher Poitras, St. Paul (CA)

(21) Appl. No.: 17/144,651

(22) Filed: Jan. 8, 2021

(51) Int. Cl. B25H 5/00

(52) U.S. Cl. CPC B25H 5/00

(57) ABSTRACT

A vehicle creeper that is configured to assist a user slidably traverse across snow or ice while under a vehicle. The vehicle creeper of the present invention includes a body wherein the body is rectangular in shape and includes a first end and second end. Formed on the first end of the body is a lip member. The lip member angles upwards from the body. The body further includes lateral longitudinal edges that are beveled in formation to inhibit snagging during a lateral sliding movement across snow or ice. The body further includes at least one pad superposed the upper surface thereof. A strap is used to secure a user to the upper surface of the body. The body is manufactured from a rigid material such as but not limited to wood or plastic.

### FIELD OF THE INVENTION

The present invention relates generally to a vehicle repair and inspection apparatus, more specifically but not by way of limitation, a vehicle and repair inspection apparatus that is operable to assist a user traverse an area underneath a vehicle when the vehicle is superposed snow and/or ice.

### BACKGROUND

Millions of vehicles traverse the roadways on a daily basis. During use of these vehicle there are occasions when the vehicles will experience a mechanical failure or issue that requires the vehicle to be pulled off the road to inspect and possibly repair in order to continue utilization of the vehicle. The aforementioned may require an individual to inspect the undercarriage of the vehicle or some part of the motor that requires observation from a bottom perspective. Typically the user will either crawl on their back in order make the necessary observations and/or repairs. Sometimes vehicle owner will utilize a creeper to move around underneath a vehicle. As is known in the art vehicle creepers have a planar support surface suitable in size to accommodate at least the torso of a human body. One side of the creeper will have a plurality of wheels so as to facilitate the rolling thereof.

One issue with conventional creepers is their inability to roll on surfaces other than smooth surfaces such as but not limited to concrete. Regardless of the type of wheels on a creeper, these wheels do not facilitate movement on alternate surface types. One example of a surface on which conventional creepers do not traverse is snow and/or ice. As drivers of vehicles utilize vehicle often during inclimate weather, it is often necessary to repair and/or inspect a vehicle on a roadside that has snow and/or ice thereon. Conventional creepers cannot traverse on snow and/or ice and it is uncomfortable for an individual to directly superpose themselves thereon.

It is intended within the scope of the present invention to provide a vehicle creeper that is designed to facilitate the traversal of a user underneath a portion of a vehicle wherein the vehicle creeper of the present invention is configured to slidably traverse across snow and/or ice.

### SUMMARY OF THE INVENTION

It is the object of the present invention to provide a vehicle creeper configured to receive a user on the upper surface so as to assist the user in slidably traversing across a surface such as snow and/or ice wherein the present invention includes a body.

Another object of the present invention is to provide a vehicle creeper operable to slidably traverse across snow and/or ice wherein the body is planar in manner and includes a first end and a second end.

A further object of the present invention is to provide a vehicle creeper configured to receive a user on the upper surface so as to assist the user in slidably traversing across a surface such as snow and/or ice wherein the first end of the body has an arcuate formation in an upwards direction.

Still another object of the present invention is to provide a vehicle creeper operable to slidably traverse across snow and/or ice wherein the upper surface of the body further includes at least one pad.

An additional object of the present invention is to provide a vehicle creeper configured to receive a user on the upper surface so as to assist the user in slidably traversing across a surface such as snow and/or ice wherein the longitudinal lateral edges of the body are rounded in formation.

Yet a further object of the present invention is to provide a vehicle creeper operable to slidably traverse across snow and/or ice that further includes a strap member having opposing portions that are configured to be releasably secured.

Another object of the present invention is to provide a vehicle creeper configured to receive a user on the upper surface so as to assist the user in slidably traversing across a surface such as snow and/or ice wherein the body is manufactured from a rigid material such as wood or plastic.

An alternate object of the present invention is to provide a vehicle creeper operable to slidably traverse across snow and/or ice wherein the body is approximately one inch in thickness.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front perspective view of an embodiment of the present invention; and

FIG. 2 is a side view of an embodiment of the present invention.

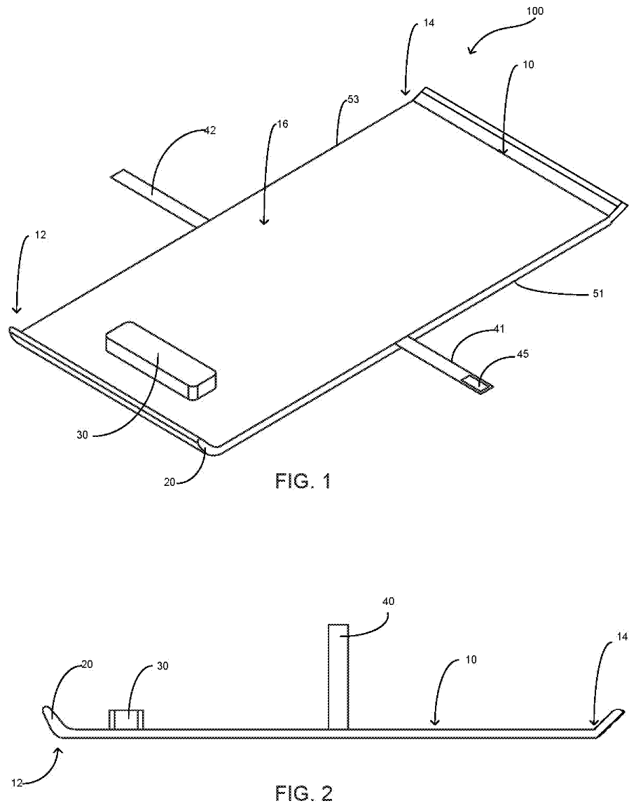

### DETAILED DESCRIPTION

References now to the drawings submitted herewith, wherein various elements depicted therein are not necessarily drawn to scale and wherein through the views and figures like elements are referenced with identical reference numerals, there is illustrated a vehicle creeper 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring to the Drawings submitted as a part hereof, the vehicle creeper 100 includes a body 10 wherein the body 10 is manufactured from a suitable rigid material such as but not limited to wood or plastic. The body 10 is generally rectangular in shape and includes a first end 12 and second end 14. While no particular size of the body 10 is required good results have been achieved by utilizing a body 10 that is approximately thirty six inches in length and eighteen inches in width. The aforementioned size is desired so as to substantially receive and provide support of a human torso. Furthermore, in a preferred embodiment the body 10 is manufactured having a thickness of approximately one inch. While the body 10 is discussed herein as having preferred dimensions it should be understood within the scope of the present invention that the body 10 could be manufactured having alternate dimensions.

Contiguously formed with the body 10 on the first end 12 thereof is the lip member 20. The lip member 20 is arcuate in formation and extends upward from the body 10. The lip member 20 extends across the full width of the body 10. While no particular height of the lip member 20 is required, it is contemplated within the scope of the present invention that the lip member 20 extends upward at least three inches so as to ensure traversal over uneven snow and ice when the vehicle creeper 100 is in use underneath a vehicle. It should be understood within the scope of the present invention that the lip member 20 could be angled upward from the body 10 in alternate angles and achieve the desired objective discussed herein. While a lip member 20 is illustrated herein as being formed on the first end 12, it is further contemplated within the scope of the present invention that the body 10 could have a second lip member formed on the second end 14 of the body. A second lip member would have a similar size and shape as the first lip member 20.

Secured to the upper surface 16 of the body 10 is a pad 30. Pad 30 is manufactured from a foam rubber or gel and is of suitable size to accommodate a human head thereon. While one pad 30 is illustrated on the body 10 herein, it is contemplated within the scope of the present invention that the body 10 could have more than one pad 30 secured to the upper surface 16.

The vehicle creeper 100 further includes a strap 40 that is operable to releasably secure a user to the upper surface 16 of the body 10. The strap 40 is a conventional nylon strap and includes a first portion 41 and second portion 42 that are releasably secured with a keeper 45. The strap 40 is secured to the body 10 on opposing sides thereof.

In a preferred embodiment of the vehicle creeper 100, the longitudinal lateral edges 51,53 of the body 10 are beveled in formed so as to inhibit the longitudinal lateral edges 51,53 from snagging on the surface on which the vehicle creeper 100 is being slidably traversed. It should be understood within the scope of the present invention that the longitudinal lateral edges 51,53 could be provided in alternate forms or have formations thereon that would assist the lateral sliding of the body 10 on snow or ice.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

1. A vehicle creeper that assists a user to slidably traverse across snow or ice wherein the vehicle creeper comprises:
a body, said body being planar in manner, said body having a first end and a second end, said body having an upper surface and a lower surface, said body having a first end and a second end; and
a lip member, said lip member being contiguously formed with either said first end or said second end of said body, said lip member extending upward from said body at a 45-degree angle to said body so as to assist in traversal of the body across snow or ice;
wherein said body further includes a first longitudinal lateral edge and a second longitudinal lateral edge, said first longitudinal lateral edge and said second longitudinal lateral edge extending intermediate the first end and said second end of said body, said first longitudinal lateral edge and said second longitudinal lateral edge being beveled without extending upward from said body.

2. (canceled)

3. The vehicle creeper as recited in claim 1, and further including at least one pad, said at least one pad being superposed on the upper surface of said body.

4. The vehicle creeper as recited in claim 3, and further including a strap, said strap extending across said body, said strap operable to releasably secure the user to the upper surface of the body.

5. The vehicle creeper as recited in claim 4, wherein said body is manufactured from wood or plastic.

6. A vehicle creeper that assists a user to slidably traverse across snow or ice wherein the vehicle creeper comprises:
a body, said body being planar in manner, said body having a first end and a second end, said body having an upper surface and a lower surface, said body having a first end and a second end, said body being rectangular in shape, said body further including a first longitudinal edge and a second longitudinal edge;
a lip member, said lip member being contiguously formed with said first end of said body, said lip member extending upward from said body at a 45-degree angle to said body so as to assist in traversal of the body across snow or ice; and
a strap, said strap having a first portion and a second portion, said first portion being secured to said body proximate said first longitudinal edge, said second portion being secured to said body proximate said second longitudinal edge;
wherein said first longitudinal lateral edge and said second longitudinal lateral edge are beveled in form without extending upward from said body.

7. (canceled)

8. The vehicle creeper as recited in claim 6, and further including at least one pad, said at least one pad being superposed on the upper surface of said body.

9. The vehicle creeper as recited in claim 8, wherein said body is approximately eighteen inches in width and thirty six inches in length.

10. The vehicle creeper as recited in claim 9, wherein said body is manufactured from wood or plastic.
